(19) United States
(12) Patent Application Publication
(10) Pub. No.: US 2006/0248087 A1
(43) Pub. Date: Nov. 2, 2006

(54) System and method for on-demand analysis of unstructured text data returned from a database

(75) Inventors: Neeraj Agrawal, New Delhi (IN); Scott R. Holmes, Morgan Hill, CA (US); Kiran Mehta, San Jose, CA (US); Sumit Negi, New Delhi (IN)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: International Business Machines Corporation, Armonk, NY (US)

(21) Appl. No.: 11/118,538

(22) Filed: Apr. 29, 2005

(51) Int. Cl. G06F 17/30

(52) U.S. Cl. 707/10

(57) ABSTRACT

A system and method of retrieving data from a database comprising unstructured data comprises specifying a text analytic component in an unstructured text query at query runtime; submitting the unstructured text query to a web service database; filtering unstructured text data in the web service database based on constraints defined in the text analytic component in the query; and receiving the filtered unstructured text data based on the submitted query from the web service database, wherein the text analytic component comprises metadata requirements. Preferably, the constraints comprise any of positive sentiments regarding an unstructured text document and negative sentiments regarding the unstructured text document. Alternatively, the constraints may comprise any of name spotting constraints, address spotting constraints, date spotting constraints, and entity spotting constraints. The filtering preferably occurs using a web-based callback service specified in a WFQL XML document. The database is preferably run on a WebFountain platform.

### BACKGROUND OF THE INVENTION

1. Field of the Invention

The embodiments of the invention generally relate to database systems and, more particularly, to queries run on database systems.

2. Description of the Related Art

Unstructured text is text data that can be in paragraph or sentence form such as text normally found in a book, World Wide Web page, newspaper, speech, etc. Conversely, structured text is text data that has some explicit format applied to it, such as text field data found in a spreadsheet, form, or traditional relational database. Currently, there is a requirement to perform some post-processing on the query data set returned from a unstructured text database, such as the WebFountain platform, available from IBM Corp., NY, USA. Generally, WebFountain is a platform for very large-scale unstructured text analytics applications. In this regard, text analytics refers to statistical and artificial intelligence methodologies used to analyze unstructured text. A description of the WebFountain platform is described in Gruhl et al., “How to build a WebFountain: An architecture for very large-scale text analytics,” IBM Systems Journal, Vol. 43, No. 1, p. 64-77, 2004 and Cass, S., “A Fountain of Knowledge,” IEEE Spectrum, p. 68-75, January 2004, the complete disclosures in their entireties are herein incorporated by reference. The requirement is that certain data is restricted from use by the client but is needed for processing to generate the necessary results after a query takes place. The result of that processing would then be available to the client as metadata. Accordingly, it is desirable to be able to retrieve unstructured text data from a database and process it using text analytics services.

### SUMMARY OF THE INVENTION

In view of the foregoing, an embodiment of the invention provides a method of retrieving data from a database comprising unstructured data, wherein the method comprises specifying a text analytic component in an unstructured text query at query runtime; submitting the unstructured text query to a web service database; filtering unstructured text data in the web service database based on constraints defined in the text analytic component in the query; and receiving the filtered unstructured text data based on the submitted query from the web service database, wherein the specifying of the text analytic component comprises adding metadata requirements to the unstructured text query. Preferably, the constraints comprise any of positive sentiments regarding an unstructured text document and negative sentiments regarding the unstructured text document. Alternatively, the constraints may comprise any of name spotting constraints, address spotting constraints, date spotting constraints, and entity spotting constraints.

Preferably, the filtering occurs using a web-based callback service specified in a WebFountain Query Language (WFQL) eXtensible Markup Language (XML) document. Moreover, the database is preferably run on a WebFountain platform. The method further comprises parsing the WFQL XML document; initializing at least one query tag object; formatting the WFQL XML document based on the query tag object; parsing the formatted WFQL XML document as query results; and generating a return XML document to a client server based on the parsed results.

Another embodiment of the invention provides a system for retrieving data from a database comprising unstructured data, wherein the system comprises a processor adapted to specify a text analytic component in an unstructured text query at query runtime; a server adapted to submit the unstructured text query to a web service database; a filter adapted to filter unstructured text data in the web service database based on constraints defined in the text analytic component in the query; and a graphic user interface adapted to receive the filtered unstructured text data based on the submitted query from the web service database, wherein the text analytic component comprises metadata requirements.

Preferably, the constraints comprise any of positive sentiments regarding an unstructured text document and negative sentiments regarding the unstructured text document. Alternatively, the constraints may comprise any of name spotting constraints, address spotting constraints, date spotting constraints, and entity spotting constraints. The filter may comprise a web-based callback service specified in a WebFountain Query Language (WFQL) eXtensible Markup Language (XML) document. Moreover, the database is preferably run on a WebFountain platform. The system further comprises means for parsing the WFQL XML document; means for initializing at least one query tag object; means for formatting the WFQL XML document based on the query tag object; means for parsing the formatted WFQL XML document as query results; and means for generating a return XML document to a client server based on the parsed results.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a preferred method of an embodiment of the invention;

FIG. 2 is an example of a WFQL that specifies two processors according to an embodiment of the invention;

FIG. 3 is a flow diagram illustrating a getEnumWS(String WFQL) according to an embodiment of the invention;

FIG. 4 is a flow diagram illustrating a getElementWS(String WFQL) and getKeysWS( . . . ) according to an embodiment of the invention;

FIG. 5 is a schematic diagram of a system according to an embodiment of the invention; and

FIG. 6 is a schematic diagram of a computer system according to an embodiment of the invention.

### DETAILED DESCRIPTION OF PREFERRED EMBODIMENTS OF THE INVENTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned, it is desirable to be able to retrieve unstructured text data from a database and process it using text analytics services. The embodiments of the invention achieve this by providing a technique that extends the WebFountain platform with analytical services that are specified at query runtime (i.e., “on-demand”). This is accomplished by specifying, within an unstructured query, analytical services that are executed against the results of the query. This query is specified as an extensible Markup Language (XML) document. Thus, as further described below, the technique provided by the embodiments of the invention extends WebFountain Query Language (WFQL) to not only specify the requested data and constraints of what data should be returned, but also how the unstructured text data should be processed prior to being returned.

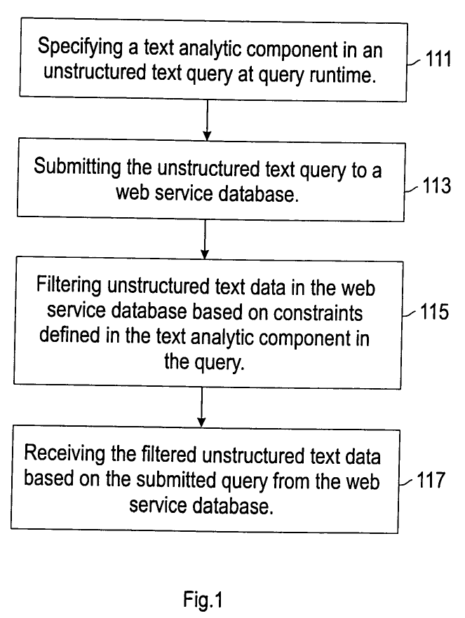

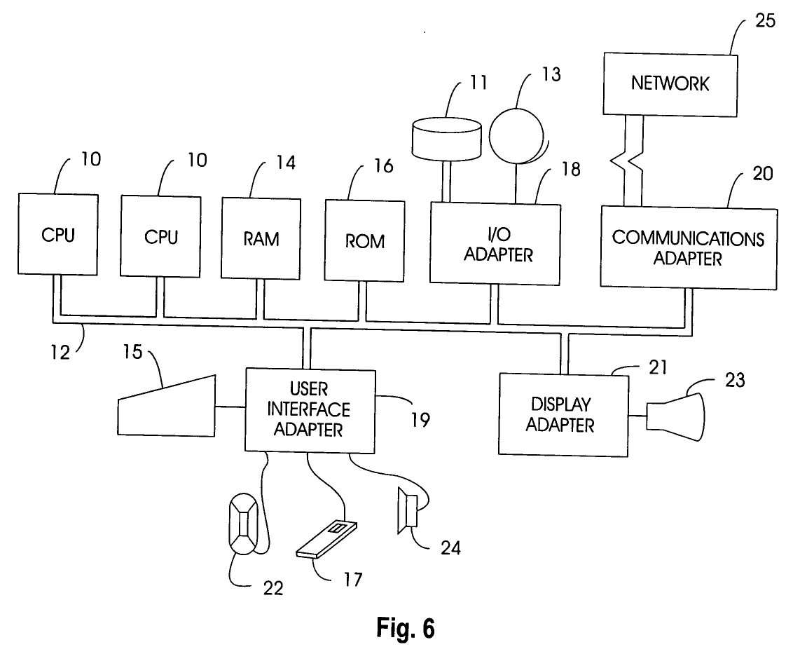

Referring now to the drawings and more particularly to FIGS. 1 through 6 where similar reference characters denote corresponding features consistently throughout the figures, there are shown preferred embodiments of the invention. FIG. 1 illustrates a method of retrieving unstructured text data from a database according to an embodiment of the invention, wherein the method comprises specifying (111) a text analytic component in an unstructured text query at query runtime; (113) submitting the unstructured text query to a web service database; (115) filtering unstructured text data in the web service database based on constraints defined in the text analytic component in the query; and receiving (117) the filtered unstructured text data based on the submitted query from the web service database.

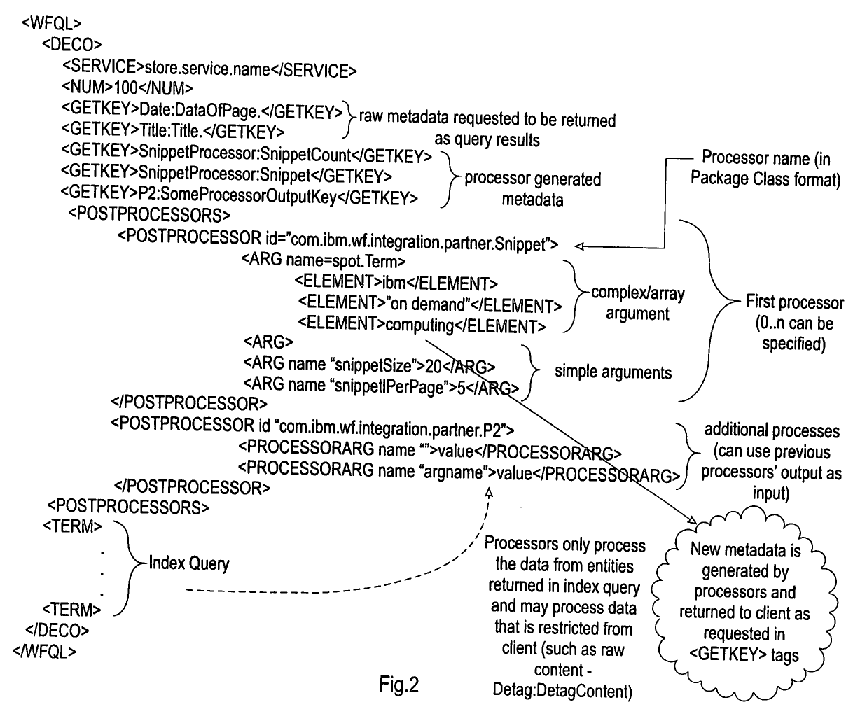

FIG. 2 illustrates an example of a WFQL that specifies two processors. Certain text analytics services have been executed on the unstructured text to yield certain metadata such as title and the date of the page represented as “Title:Title” and “Date:DateOfPage”. The query specifies additional metadata that would be returned referred to as SnippetProcessor:Snippet and SnippetProcessor:SnippetCount as well as a generic example metadata element such as “P2:SomeProcessorOutputKey”. The “POSTPROCESSORS” element describes which text analytic services are necessary to invoke (and with what configuration) to produce the requested metadata.

The PostProcessor exists on a server side as a Java® class that has a fully qualified name that corresponds to the “id” attribute of the POSTPROCESSOR tag. A POSTPROCESSOR refers to a text analytics service that is responsible for generating metadata. The processor has a constructor that requires no arguments for initialization to support runtime instantiation and implements the following interface:

public interface Postprocessor {

public void init(String xmlArgs);
public String[] getRequestedKeys( );
public String process(DataElementList resultDataElements);

}

An implementation of this interface is preferably located in the CLASSPATH environment of the WebFountain WebService container. The CLASSPATH specifies the location in the environment where the text analytic service could be dynamically loaded at runtime. The most simple deployment mechanism for PostProcessor implementations is through access to the machine through a remote copy mechanism such as a File Transport Protocol (FTP). Deployment may be supported through a HTTP transfer by the specification of a universal resource locator (URL) in the POSTPROCESSOR tag embedded in the query that references the compiled code so that it may be loaded at runtime. This offers a great degree of flexibility because the client could specify remote text analytic services that do not need to be explicitly deployed prior to runtime. A graphic user interface (GUI) that is hosted on the WebFountain platform may also be offered as a deployment mechanism.

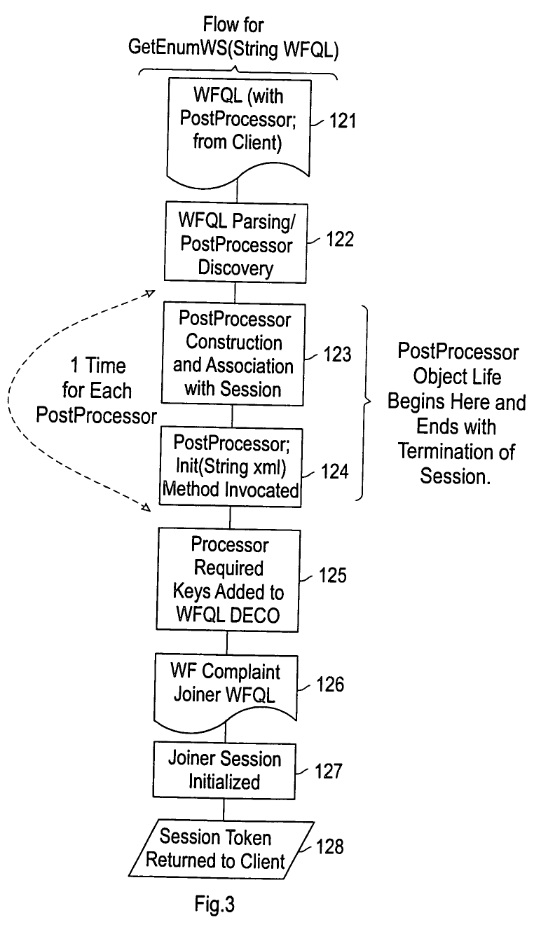

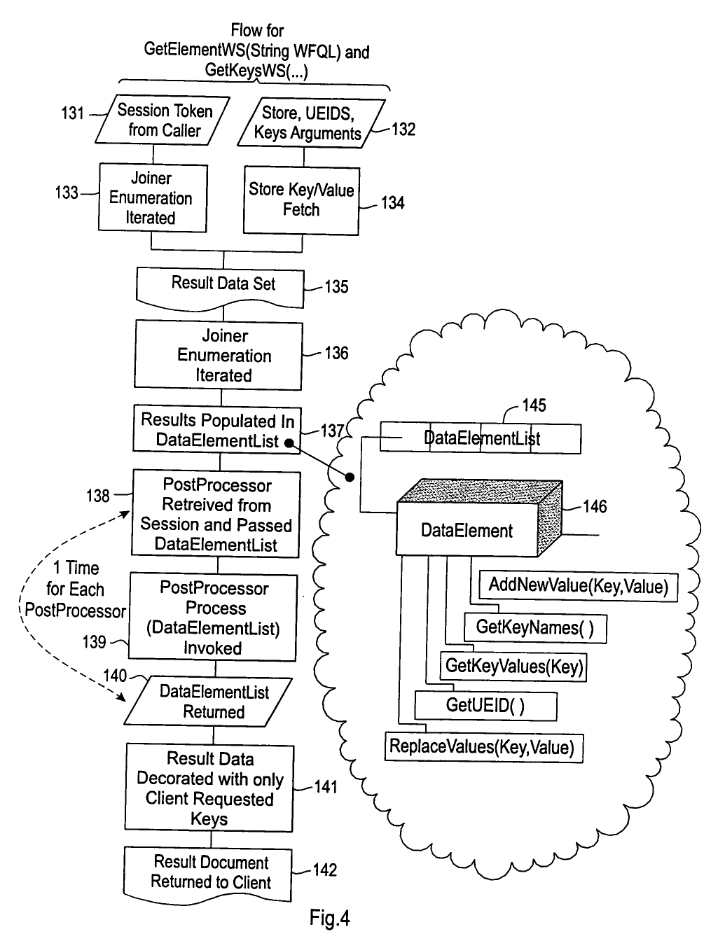

FIGS. 3 and 4 illustrate alternate flow diagrams of preferred embodiments of the invention. FIG. 3 describes the execution of a query which initializes the text analytics service components appropriately. First, a query document including the specified text analytic service components is sent (121) to the database. The document is parsed (122) and the text analytic service components are discovered. The text analytics components are then instantiated and associated (123) with the query in a session. The component is then initialized (124) with some specific configuration arguments provided in the query document. The input data requirements for the components are discovered (125) and then the system expands the query to also request (126) this data from the database platform. The query is transformed into a traditional query that contains no service component specification and that is sent (127) to the lower levels of the database system. A session id is then returned (128) to the client so that the client can use this id to iterate through generated results.

Generally, the process begins with a WFQL XML document (121) being parsed (122) using an XML parser that is aware of the schema of the query language. The WebFountain WebServices container discovers PostProcessors specified in WFQL and instantiates (123) the appropriate PostProcessor text analytic component using a dynamic library loader such as the Class.forName( ) functionality in Java®. If the library is not found, an exception is thrown to the client server indicating that the library could not be located. This would be an exception that is similar to a java.lang.ClassNotFoundException in Java®. Next, PostProcesor(s) are initialized through the invocation of an init method (124) with some configuration arguments that are specified in the query passed as parameters. The client code specifies one or more processors in the decoration section of a WFQL document. The processor is specified by an “id” and configured with a set of arguments. Arguments can be simple data strings or multiple elements (arrays) of strings. In addition to this, the database platform low level components, name and index name, are passed as arguments to all processors as references.

This allows the text analytics services to access the low level components if the service implementations require such functionality. The service component implementation is responsible for parsing the arguments to apply the query specified configuration. Analytic service objects (PostProcessors) are saved in the session through a generic persistence mechanism which preserves the order of their execution.

Now that the processing components configuration has been saved, the query is transformed such that any processing specification is removed so that the query is simply fetching data from the database based on certain constraints. The metadata requirements of the text analytic service components are added to the query so that the required metadata and unstructured text data is fetched from the database system. Then, the query executes as would a normal query and a session id is returned (128) to the client server. As the client server requests, an iteration service is invoked and the raw result is returned by the database system.

FIG. 4 describes the process of the iteration through and processing of the query results. Either a session id is specified (131) and a joiner enumeration is iterated (133) or particular universal entity identifiers (UEIDS) (or primary keys) (132) are specified for the request of the data and the data is fetched (134) and the results (135, 136) are populated (137) into a data structure that can be accessed and populated or by a text analytics service component chain for processing (138, 139). After processing has completed and the results have been included (140) in the data structure, the system accesses (141) only the client requested metadata and includes these in the document that is returned (142) to the client.

The result is parsed and a non-prunable collection object is created called the DataElementList 145. The DataElementList 145 is populated with an instance of the DataElement class through the insertion of metadata. DataElements 146 provide an abstract representation of each entity. DataElements can be added but not removed from the DataElementList so that all data is available for other text analytic service components that may be executed at a later time. Subsequently, the DataElementList 145 is passed to each processor as a referenced datastructure. The chaining text analytics service components are possible because each DataElement 146 in the DataElementList 145 is populated with the output of the PostProcessor. Thereafter, Decoration Keys are specified by the client as <GETKEY> elements and are extracted from the DataElementList 145, and are populated in the XML return document as character data in elements that correspond to the requested metadata.

According to the embodiments of the invention, a callback service is specified in a WFQL XML document that a certain callback object should be used to process, on demand, the results of a query as described above. This technique is extendable (i.e., new callbacks can be created and “plugged” in for different purposes). It abstracts the required keys from the developer. There is no change in WebService signature, only in the WFQL document that is passed to these WebServices to allow for flexibility service behavior with the service signature contract remaining static. This is important because it facilitates efficient versioning by avoiding a requirement for interface code changes.

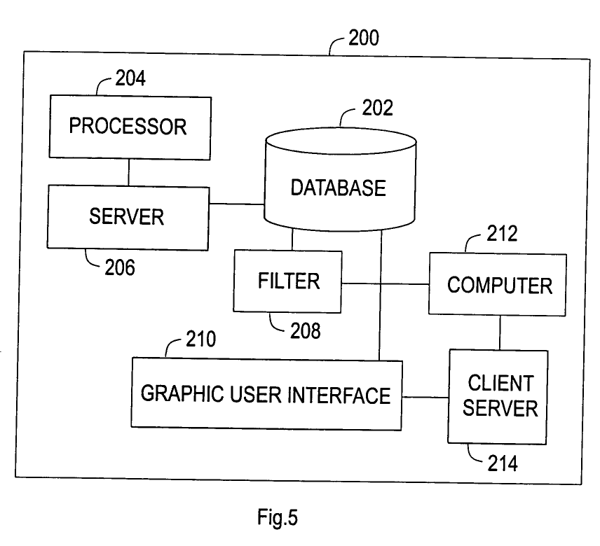

FIG. 5 illustrates a system 200 for retrieving data from a database 202, wherein the system 200 comprises a processor 204 adapted to specify a text analytic component in an unstructured text query at query runtime; a server 206 adapted to submit the unstructured text query to a web service database 202; a filter 208 adapted to filter unstructured text data in the web service database 202 based on constraints defined in the text analytic component in the query; and a graphic user interface 210 adapted to receive the filtered unstructured text data based on the submitted query from the web service database 202. The constraints may comprise any of positive sentiments regarding an unstructured text document and negative sentiments regarding the unstructured text document. Furthermore, the constraints may comprise any of name spotting constraints, address spotting constraints, date spotting constraints, and entity spotting constraints. Also, the filter 208 comprises a web-based callback service specified in a WFQL XML document. Preferably, the database 202 is run on a WebFountain platform. Furthermore, the system 200 comprises a computer 212 adapted to (a) parse the WFQL XML document, (b) initialize at least one query tag object, (c) format the WFQL XML document based on the query tag object, (d) parse the formatted WFQL XML document as query results, and (e) generate a return XML document to a client server 214 based on the parsed results.

A representative hardware environment for practicing the embodiments of the invention is depicted in FIG. 3. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The embodiments of the invention provide a system and method for specifying, within an unstructured query, analytical services that are executed against the results of the query. This query is preferably specified as an XML document. Accordingly, the embodiments of the invention allow for the processing of raw unstructured content that has a restriction such that clients are unable to access this data. An example is data that is subject to copyright restrictions and cannot be redistributed. The client is thus allowed to apply analytical services for generation of results without violating copywrite protection. Furthermore the execution of services at runtime allows for processing on the results of a query which reduces the overall amount of execution required (assuming that the result set is almost always smaller than the corpus size).

This provides for a system that executes these services on a select data set that is specifically what is required by a client and not all data in the corpus as would be previously required. The embodiments of the invention achieve these features by providing a technique that specifies a text analytic component in an unstructured text query at query runtime, submits the unstructured text query to a web service database, filters unstructured text data in the web service database based on constraints defined in the text analytic component in the query; and receives the filtered unstructured text data based on the submitted query from the web service database.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method of retrieving data from a database comprising unstructured data, said method comprising:
specifying a text analytic component in an unstructured text query at query runtime;
submitting said unstructured text query to a web service database;
filtering unstructured text data in said web service database based on constraints defined in said text analytic component in said query; and
receiving the filtered unstructured text data based on the submitted query from said web service database.

2. The method of claim 1, wherein said constraints comprise any of positive sentiments regarding an unstructured text document and negative sentiments regarding said unstructured text document.

3. The method of claim 1, wherein said constraints comprise any of name spotting constraints, address spotting constraints, date spotting constraints, and entity spotting constraints.

4. The method of claim 1, wherein said filtering occurs using a web-based callback service specified in a WebFountain Query Language (WFQL) extensible Markup Language (XML) document.

5. The method of claim 1, wherein said database is run on a WebFountain platform.

6. The method of claim 1, wherein said specifying of said text analytic component comprises adding metadata requirements to said unstructured text query.

7. The method of claim 4, further comprising:
parsing said WFQL XML document;
initializing at least one query tag object;
formatting said WFQL XML document based on said query tag object;
parsing the formatted WFQL XML document as query results; and
generating a return XML document to a client server based on the parsed results.

8. A program storage device readable by computer, tangibly embodying a program of instructions executable by said computer to perform a method of retrieving data from a database comprising unstructured data, said method comprising:
specifying a text analytic component in an unstructured text query at query runtime;
submitting said unstructured text query to a web service database;
filtering unstructured text data in said web service database based on constraints defined in said text analytic component in said query; and
receiving the filtered unstructured text data based on the submitted query from said web service database.

9. The program storage device of claim 8, wherein said constraints comprise any of positive sentiments regarding an unstructured text document and negative sentiments regarding said unstructured text document.

10. The program storage device of claim 8, wherein said constraints comprise any of name spotting constraints, address spotting constraints, date spotting constraints, and entity spotting constraints.

11. The program storage device of claim 8, wherein said filtering occurs using a web-based callback service specified in a WebFountain Query Language (WFQL) eXtensible Markup Language (XML) document.

12. The program storage device of claim 8, wherein said database is run on a WebFountain platform.

13. The program storage device of claim 11, wherein said method further comprises:
parsing said WFQL XML document;
initializing at least one query tag object;
formatting said WFQL XML document based on said query tag object;
parsing the formatted WFQL XML document as query results; and
generating a return XML document to a client server based on the parsed results.

14. The program storage device of claim 8, wherein said specifying of said text analytic component comprises adding metadata requirements to said unstructured text query.

15. A system for retrieving data from a database comprising unstructured data, said system comprising:
a processor adapted to specify a text analytic component in an unstructured text query at query runtime;
a server adapted to submit said unstructured text query to a web service database;
a filter adapted to filter unstructured text data in said web service database based on constraints defined in said text analytic component in said query; and
a graphic user interface adapted to receive the filtered unstructured text data based on the submitted query from said web service database.

16. The system of claim 15, wherein said constraints comprise any of positive sentiments regarding an unstructured text document and negative sentiments regarding said unstructured text document.

17. The system of claim 15, wherein said constraints comprise any of name spotting constraints, address spotting constraints, date spotting constraints, and entity spotting constraints.

18. The system of claim 15, wherein said filter comprises a web-based callback service specified in a WebFountain Query Language (WFQL) eXtensible Markup Language (XML) document.

19. The system of claim 15, wherein said database is run on a WebFountain platform, and wherein said text analytic component comprises metadata requirements.

20. The system of claim 18, further comprising:
means for parsing said WFQL XML document;
means for initializing at least one query tag object;
means for formatting said WFQL XML document based on said query tag object;
means for parsing the formatted WFQL XML document as query results; and
means for generating a return XML document to a client server based on the parsed results.
